(19) United States
(12) Patent Application Publication
(10) Pub. No.: US 2009/0299571 A1
(43) Pub. Date: Dec. 3, 2009

(54) Car-mounted device and method of inserting modules

(75) Inventor: Syuuji Yamada, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/453,923

(22) Filed: May 27, 2009

(30) Foreign Application Priority Data
May 30, 2008 (JP) 2008-143734
May 30, 2008 (JP) 2008-143736

(51) Int. Cl. G06F 7/00

(52) U.S. Cl. 701/36

(57) ABSTRACT

A car-mounted device comprising a plurality of slots for inserting modules; detection units for detecting the states where the modules are inserted in the slots; and a control unit for issuing a notice based on the states where the modules are inserted detected by the detection units; wherein if the detection unit detects the module that is incompletely inserted in the slot, then the control unit decides if the module may come in contact with the constituent portion of the car-mounted device due to the operation of the constituent portion and issues an attention notice.

This application is a new U.S. patent application that claims benefit of JP 2008-143734 and 2008-143736, filed May 30, 2008, the contents of 2008-143734 and 2008-143736 are incorporated herein by reference.

### FIELD OF THE INVENTION

This invention relates to a car-mounted device and method of inserting modules. More particularly, the invention relates to a car-mounted device provided with a plurality of slots in which modules are to be inserted and a method of inserting modules in the slots.

### BACKGROUND OF THE INVENTION

There have been known car-mounted devices such as a navigation device and an audio device mounted on a vehicle and having a slot in which a card such as a memory card or a PC card is to be inserted. The card may be equipped with a tuner for receiving TV broadcasts or incorporating a communication module for adding communication functions to the car-mounted device. Inserting the card into the slot in the car-mounted device makes it possible to selectively add functions to the car-mounted device.

FIG. 1 shows a conventional car-mounted device equipped with a slot in which the card is to be inserted (for example, refer to Japanese Unexamined Patent Publication No. 2007-193699). FIG. 1 shows a conventional navigation device which uses a lid and a display unit in common, wherein FIG. 1a is a perspective view of a state where a display unit 1015A that also serves as a lid is closed, and FIG. 1b is a perspective view of a state where the display unit 1015A that also serves as the lid is opened. As shown in FIG. 1b, various functions can be exhibited by inserting a PC card 1002 in a card insertion slot 1003 that appears in a state where the display unit 1015A is opened.

However, a conventional car-mounted device was only provided with one slot and it was difficult to provide a plurality of slots fox simultaneously adding a plurality of functions or for managing the state where a plurality of modules were inserted in the slots.

Further, if the plurality of modules were simultaneously used in the car-mounted device, the user found it difficult to comprehend which module functions could be utilizable and which module functions were added.

Further, it was difficult to manage the ejection of the modules after the modules were inserted in the slots. For example, there was a probability of corruption of data stored in a memory of a module in case the module was suddenly ejected while communication was being conducted between the main body and the module or between the module and another module.

### SUMMARY OF THE INVENTION

A car-mounted device of the present invention comprises a plurality of slots for inserting modules, detection units for detecting the states where the modules are inserted in the slots, and a control unit for issuing a notice based on the states where the modules are inserted detected by the detection units, wherein if the detection unit detects the module that is incompletely inserted in the slot, then the control unit decides if the module may come in contact with the constituent portion of the car-mounted device due to the operation of the constituent portion and issues an attention notice.

The invention is also concerned with a method of inserting modules in the slots of a car-mounted device having a plurality of slots for inserting modules therein, comprising the steps of detecting the states where the modules are inserted in the slots, and issuing a notice based on the detected states where the modules are inserted, wherein if it is detected that the insertion in the slots is not complete, then it is determined if the module may come in contact with the constituent portion of the car-mounted device due to the operation of the constituent portion and an attention notice is issued.

The car-mounted device of the invention comprises a plurality of slots for inserting modules, switches for ejecting the modules inserted in the slots, and a control unit for controlling the operating states of the modules inserted in the slots and ejection of the modules from the slots, wherein if a switch is operated in a state where the module is in operation, the module is prevented from being ejected.

Further, the car-mounted device of the invention comprises a first unit having an operation portion, a second unit having slots for inserting modules, a moving portion covering the operation portion of the first unit and the slots of the second unit, and a control unit for controlling the operation of the moving portion, wherein if the operation portion only of the first unit is operated, the moving portion is controlled so that the slots of the second unit are not exposed.

The car-mounted device of the invention is operated while detecting the states where the modules are inserted in the slots. Therefore, the modules are prevented from being broken by the operation of the car-mounted device.

There are also displayed tabs related to the module functions inserted in the slots and related functions in a state where they can be used, and the user is allowed to recognize which modules are utilizable and what kind of functions are added.

The car-mounted device of the present invention detects the states where the modules are inserted in the slots, and controls the operation for ejecting the modules. Therefore, the data stored in a memory of the modules are prevented from being corrupted by the operation of the car-mounted device.

### DESCRIPTION OF THE DRAWINGS

These and other features and advantages of the present invention will be better understood by reading the following detailed description, taken together with the drawings wherein:

FIG. 1a is a perspective view of a conventional navigation device, and FIG. 1b is a perspective view of a state where a display unit 1015A of the conventional navigation device is opened;

FIG. 2 is a diagram of a hardware constitution of a car-mounted device of the invention and modules;

FIG. 3 is a system block diagram of the car-mounted device according to an embodiment 1 of the invention and an extension module;

FIG. 4 is a system block diagram of the car-mounted device according to an embodiment 2 of the invention and the extension module;

FIG. 5 is a system block diagram of the car-mounted device according to an embodiment 3 of the invention and the extension module;

FIG. 6a is a schematic view of the car-mounted device as viewed from the front surface thereof in a state where a display unit 1000 is closed, FIG. 6b is a sectional view along A-A in FIG. 6a, FIG. 6c illustrates a state where the front surface of the car-mounted device 1 is exposed by tilting the display unit 1000, and FIG. 6d is a sectional view along B-B in FIG. 6c;

FIG. 7a is a schematic view of the car-mounted device as viewed from the front surface thereof in a state where the display unit 1000 is closed, FIG. 7b is a sectional view along C-C in FIG. 7a, FIG. 7c is a front view of when the display unit 1000 is returned back to the initial position, and FIG. 7d is a sectional view along D-D in FIG. 7c;

FIG. 8 is a flowchart of from when the car-mounted device of the invention is opened until when it is closed;

FIG. 9a is a view illustrating a display screen after a new module is inserted, and shows a display screen prior to inserting the module in a state where an AM tuner is in operation, FIG. 9b shows a display screen of when a TV tuner for one segment broadcasting is inserted in a slot, and FIG. 9c shows a display screen of when an AUX module is added;

FIG. 10a is a display screen of when a related function is added accompanying the addition of a new module in the car-mounted device of the invention, i.e., a display screen of when a navigation module is inserted while the AM tuner operation screen is being displayed, and FIG. 10b shows an information screen that is displayed when an information key that is the escutcheon key is depressed for confirming the function related to the navigation function;

FIG. 11a is a display screen of when a TV tuner module is ejected in the car-mounted device of the invention, and FIG. 11b is an information screen of when the navigation module is ejected;

FIG. 12a is a display screen after the module is inserted in the car-mounted device of the invention and illustrates an example of when a TV tuner module for one segment broadcasting is inserted while the AM tuner is in operation, FIG. 12b illustrates an example of displaying only a button for selecting whether the display be made in the frame of display, and FIG. 12c illustrates an example of when a module of the same kind is inserted, the module, however, being of a version different from that of the module inserted in the past;

FIG. 13a is a schematic view of when the car-mounted device is viewed from the front surface thereof in a state where the display unit 1000 is closed, FIG. 13b is a sectional view along A-A in FIG. 13a, FIG. 13c shows a state where the front surface of the car-mounted device is partly exposed by tilting the display unit by using a slide mechanism, and FIG. 13d is a sectional view along B-B in FIG. 13c;

FIG. 14a illustrates a state where the front surface of the car-mounted device is partly exposed by tilting the display unit by using the slide mechanism, i.e., a state where a second extension module is inserted in the slot for inserting the second module, FIG. 14b is a sectional view along C-C in FIG. 14a, FIG. 14c is a front view of when the display unit is returned back to the initial position, and FIG. 14d is a sectional view along D-D in FIG. 14c;

FIG. 15 is a flowchart of from when the module is inserted in the car-mounted device of the invention until when it is ejected;

FIG. 16 is a display screen of when an eject button is depressed in the car-mounted device of the present invention:

FIG. 17 is a display screen of when the eject button is depressed in the car-mounted device of the present invention;

FIG. 18a is a schematic view of the front surface of an operation panel in the car-mounted device of the invention and illustrates a state where the lid is closed, and FIG. 18b is a schematic view of the front surface of the operation panel in a state where the lid is opened; and

FIG. 19 is a flowchart of from when the module is inserted in the car-mounted device of the invention until it is ejected.

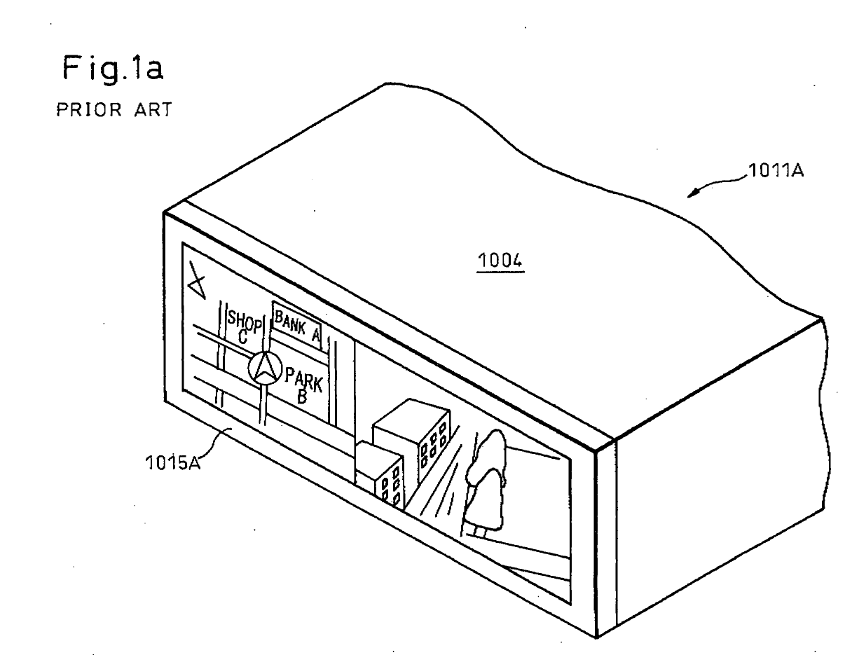

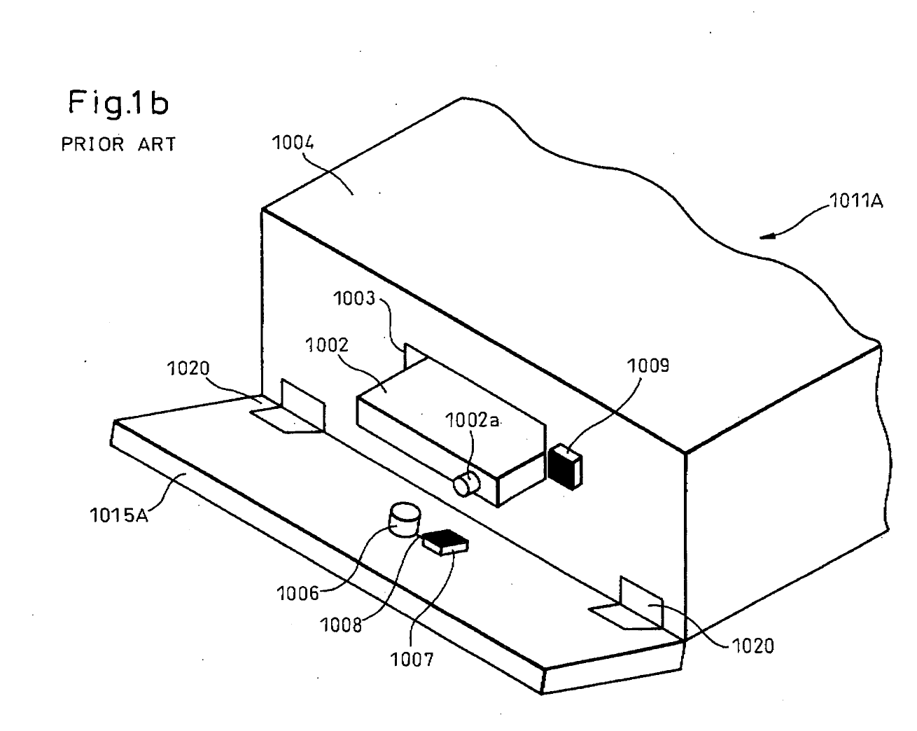

### DETAILED DESCRIPTION OF THE PREFERRED EMBODIMENTS

The car-mounted device and the method of inserting modules according to the invention will now be described with reference to the drawings. However, it should be noted that the technical scope of the invention is not limited by the mode of the embodiments but encompasses the invention described in the claims and equivalence thereof.

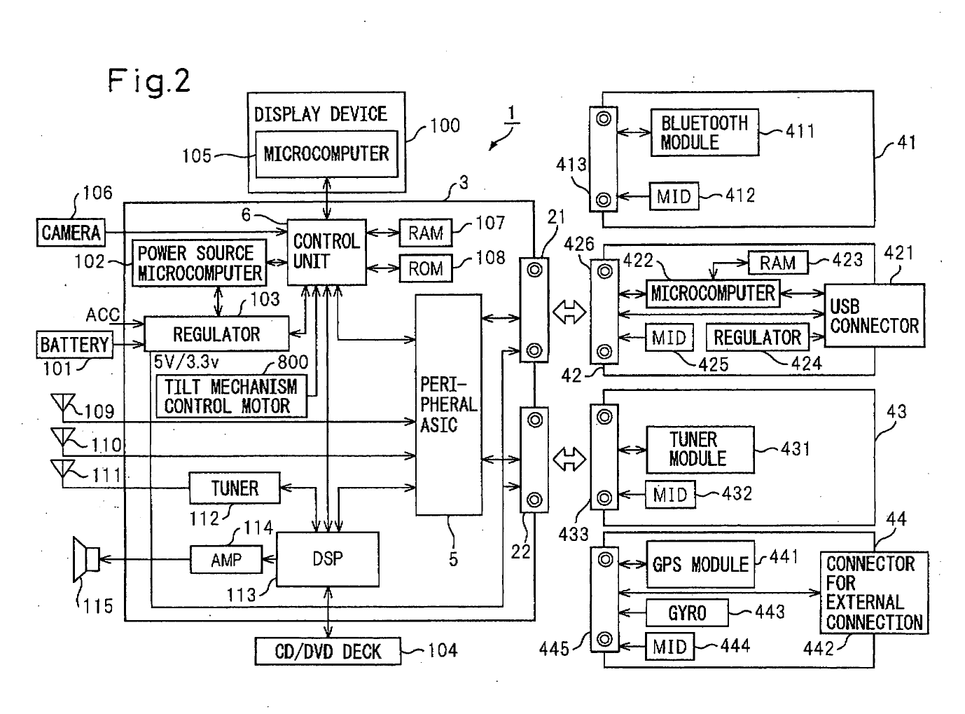

First, an embodiment of a hardware constitution in the car-mounted device of the invention will be described with reference to FIG. 2. The car-mounted device 1 of the invention has a main unit 3 provided with a first connector 21 formed in a first slot and a second connector 22 formed in a second slot. In addition to the main unit, basic devices such as a picture display device 100 and a CD/DVD deck 104 are connected to the car-mounted device 1. Extension modules 41 to 44 can be inserted in each of the slots. The connectors 21, 22 have a plurality of terminals for executing communication relative to the extension modules 41 to 44 after they have been inserted. The extension modules are modules separate from the car-mounted device and work to extend the functions of the car-mounted device. For instance, a Bluetooth (registered trademark) module 41, a USB interface module 42, a digital TV module 43, and a navigation module 44 can be used as extension modules. The embodiment of FIG. 2 illustrates a state where the USB interface module 42 and the digital TV module 43 are inserted in the slots.

The terminals in each slot are connected to a peripheral ASIC 5 provided in the main unit 3 enabling the communication to be executed between the extension modules 42 and 43. In FIG. 2, the extension modules 42 and 43 are inserted in the slots and are electrically connected to the terminals provided in the slots. The main unit 3 is, further, provided with a control unit 6 for controlling the peripheral ASIC 5, and controls the extension modules 42 and 43. As described above, the car-mounted device 1 of the present invention has a feature in the provision of a plurality of slots for permitting a plurality of extension modules 42 and 43 to work simultaneously.

The display device 100 provided for the car-mounted device 1 is so disposed as to cover the operation portion of the CD/DVD deck 104 as well as the first slot forming the first connector 21 and the second slot forming the second connector 22. The display device 100 is controlled by a tilt mechanism control motor 800 when the disk and modules are to be inserted in, and taken out from the operation portion of the CD/DVD deck 104 and the first slot and the second slot.

The power source of the main unit 3 is supplied from a battery 101 and the voltage is adjusted by a regulator 103 that is controlled by a power source microcomputer 102. The electric power for the inserted extension modules is also supplied from the regulator 103.

Picture signals from the inserted extension modules are sent from the control unit 6 to a microcomputer 105 in the display device 100 to display a desired picture. It is also allowable to obtain the picture data on the outside of the car-mounted device from a camera 106.

To the control unit are connected a RAM 107 and a ROM 108. The RAM 107 is capable of storing a module ID (MID) for identifying the extension module. The ROM 108 is capable of storing an MID for a module that can be used in the car-mounted device.

A GPS antenna 109, a digital TV antenna 110 and a radio antenna 111 are installed on the outside of the car-mounted device. Electromagnetic waves received by the GPS antenna 109 and by the digital TV antenna 110 are fed to the terminals in the slot. When the navigation device and the digital TV tuner are used as the extension modules, the received signals are fed thereto. Further, the main unit 3 of the car-mounted device 1 incorporates an AM/FM tuner 112, and is capable of feeding the signals received by the radio antenna 111 to the AM/FM tuner 112.

The main unit 3 in the car-mounted device 1 incorporates a digital signal processor (DSP) 113, and is capable of feeding, to an AMP 114, the voice signals from the extension module such as the AM/FM tuner 112, CD/DVD deck 104 or memory audio so that they are output from a speaker 115.

The Bluetooth (registered trademark) module 41 feeds signals from a Bluetooth (registered trademark) module unit 411 and MID 412 signals to a terminal 413. If the Bluetooth (registered trademark) module 41 is inserted in the slot of the car-mounted device 1, the MID 412 specific to the Bluetooth (registered trademark) module 41 is sent to the car-mounted device 1, and is compared with an ID stored in advance in the RAM 107 or the ROM 108 to decide if it can be used in the car-mounted device 1. If usable, the module is registered in the control unit 6, and the user is allowed to recognize that the module can be used on the display device 100.

The USB interface module 42 includes a USB connector 421, a microcomputer 422, a RAM 423 and a regulator 424. When the USB interface module 42 is inserted in the slot of the car-mounted device 1, signals from an external unit connected to the USB connector 421 and MID 425 specific to the USB interface module 42 are sent to the car-mounted device 1 via a terminal 426. The MID 425 is compared with an ID stored in advance in the RAM 107 or the RON 108 to decide if the module can be used in the car-mounted device 1. If usable, the module is registered in the control unit 6, and the user is allowed to recognize that the module can be used on the display device 100.

The digital tuner module 43 includes a tuner module 431. When the digital tuner module 43 is inserted in the slot of the car-mounted device 1, signals from the tuner module 431 and MID 432 specific to the digital tuner module 43 are sent to the car-mounted deice 1 via a terminal 433. The MID 432 is compared with an ID stored in advance in the RAM 107 or the ROM 108 to decide if the module can be used in the car-mounted device 1. If usable, the module is registered in the control unit 6, and the user is allowed to recognize that the module can be used on the display device 100.

The navigation module 44 includes a GPS module 441, a connector 442 for external connection and a gyro 443. When the navigation module 44 is inserted in the slot of the car-mounted device 1, signals from the GPS module 441, connector 442 for external connection and gyro 443 as well as MID 444 specific to the navigation module 44 are sent to the car-mounted device 1 via a terminal 445. The MID 444 is compared with an ID stored in advance in the RAM 107 or the ROM 108 to decide if the module can be used in the car-mounted device 1. If usable, the module is registered in the control unit 6, and the user is allowed to recognize that the module can be used on the display device 100.

As described above, the car-mounted device is provided with a plurality of slots, and various extension modules are inserted in the slots. In this case, a specific ID (MID) is identified for each of the modules to acknowledge the details of the inserted module preventing the use of modules that are produced without authorization.

When the module is used by being inserted in the slot as described above, it is necessary to manage the state where the module is inserted to prevent the breakage of the module. Next, described below is the constitution of the car-mounted device for detecting the state where the module is inserted.

### Embodiment 1

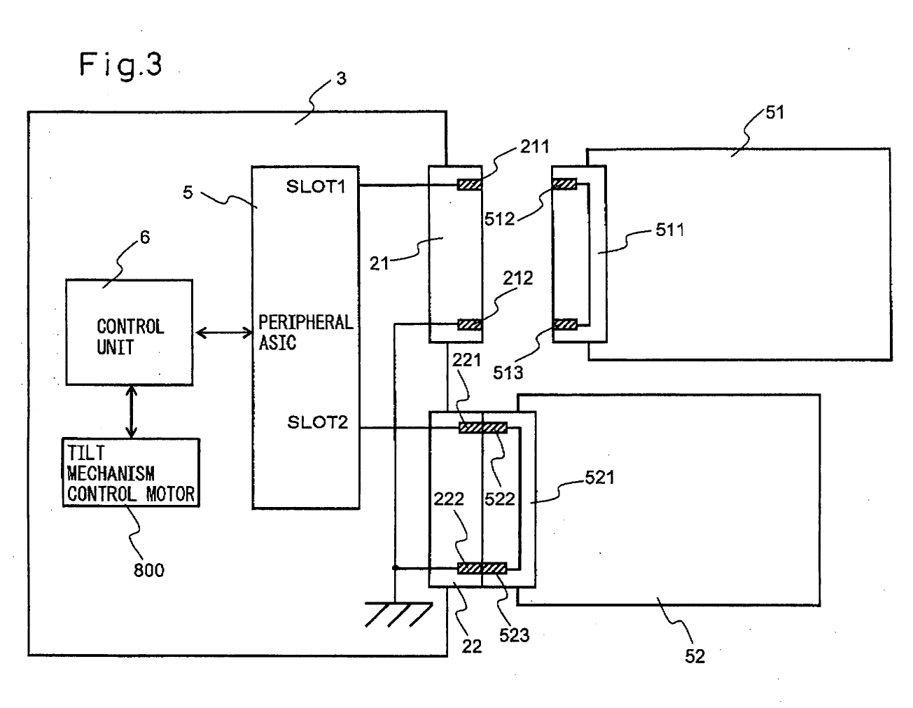

FIG. 3 is a diagram schematically illustrating the constitution of the car-mounted device according to an embodiment 1 of the invention. The main unit 3 of the car-mounted device has two slots. In the car-mounted device according to the embodiment 1, the connectors 21, 22 are each provided with a pair of terminals as detection units for detecting the extension modules 51 and 52 that are inserted in the slots. The constitution shown in FIG. 3 schematically illustrates a state where the first extension module 51 has not been inserted in the first slot in which the first connector 21 is formed and a state where the second extension module 52 has been inserted in the second slot in which the second connector 22 is formed.

The first connector 21 is provided with the pair of terminals 211 and 212, the first terminal 211 being connected to a terminal SLOT1 of the peripheral ASIC 5 to detect the connected state. The second terminal 212 is grounded. A first terminal 512 and a second terminal 513 of a connector 511 of the first extension module 51 are disposed at positions corresponding to the first terminal 211 and the second terminal 212 of the first connector 21, and are connected together. The first extension module 51 is not connected to the first connector 21 and, therefore, the terminal SLOT1 of the peripheral ASIC 5 assumes a voltage of a high level.

Next, described below is a method of detecting the extension module that is inserted in the slot. If the second extension module 52 is connected to the second connector 22 in the second slot, the first terminal 221 and the second terminal 222 of the second connector are connected to a first terminal 522 and a second terminal 523 of a connector 521 of the second extension module 52. The first terminal 522 and the second terminal 523 of the second extension module 52 have been connected together. Therefore, if the second extension module 52 is connected to the second connector, then the voltage at the terminal SLOT2 of the peripheral ASIC 5 changes into a low level (0 V). Upon detecting a change in the voltage level, it is allowed to detect the module that is inserted in the slot. The detection signal is sent from the peripheral ASIC 5 to the control unit 1, and the result is displayed on the display unit so as to be notified to the user.

Since the modules inserted in the slots are detected in a manner as described above, it is made possible to individually identify the modules that are inserted in the plurality of slots.

### Embodiment 2

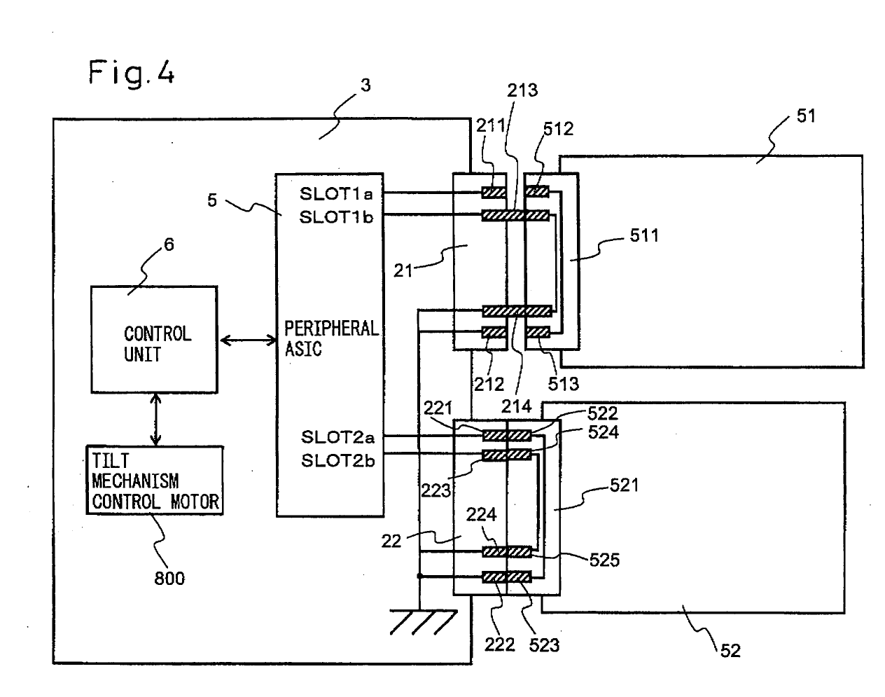

FIG. 4 illustrates the constitution of the car-mounted device and modules according to an embodiment 2. The embodiment 2 has a feature in the provision of two pairs of terminals 211 to 214 having different terminal lengths as detection units for detecting the modules. The main unit 3 of the car-mounted device has two slots. In the car-mounted device according to the embodiment 2, the connectors 21 and 22 are each provided with two pairs of terminals as detection units for detecting the extension modules 51 and 52 that are inserted in the slots, the one pair of terminals (213, 214) having a longer terminal length than the other pair of terminals (211, 212). The constitution shown in FIG. 4 schematically illustrates a state where the first extension module 51 is inserted in the first slot in which the first connector 21 is formed, the insertion, however, being incomplete, while the second extension module 52 is completely inserted in the second slot in which the second connector 22 is formed.

The first connector 21 is provided with a pair of terminals 211, 212 and another pair of terminals 213, 214 having a larger terminal length. The first terminal 211 and the third terminal 213 are connected to the terminal SLOT1a and the terminal SLOT1b of the peripheral ASIC 5 to detect the state of connection. The second terminal 212 and the fourth terminal 214 are grounded. The first terminal 512 to fourth terminal 515 of the connector 511 of the first extension module 51 are disposed at positions corresponding to the first terminal 211 to the fourth terminal 214 of the first connector 21. The first terminal 512 is connected to the second terminal 513, and the third terminal 514 is connected to the fourth terminal 515. In FIG. 4, the first extension module 51 is connected to the first connector 21 in the first slot but is inserted incompletely. That is, the third terminal 514 and the fourth terminal 515 of the first extension module 51 are connected to the third terminal 213 and the fourth terminal 214 constituting the pair of terminals of the large length of the first connector. The terminal SLOT1b of the peripheral ASIC 5 assumes a voltage of the low level, and the inserted state is detected. On the other hand, the first terminal 211 of the first connector is not connected to the first terminal 512 of the first extension module 51. Therefore, there is no change in the voltage level at the terminal SLOT1a of the peripheral ASIC 5, and the state of no insertion is detected. Upon detecting the voltage levels at the terminals SLOT1a and SLOT1b, it is detected that the first extension module 51 has not been completely connected to the first connector.

Next, described below is a method of detection of when the extension module is completely inserted in the slot. If the second extension module 52 is connected to the second connector 22 in the second slot, the first terminal 221 to fourth terminal 224 of the second connector are connected to the first terminal 522 to fourth terminal 525 of the connector 521 of the second extension module 52. The first terminal 522 has been connected to the second terminal 523, and the third terminal 524 has been connected to the fourth terminal 525 in the second extension module 52. Therefore, if the second connector is connected to the second extension module 52, the voltage changes into the low level (0 V) at the terminal SLOT2a and at the terminal SLOT2b of the peripheral ASIC 5. Upon detecting the change in the voltage level, the module is detected to have been completely inserted in the slot. The detection signal is sent from the peripheral ASIC 5 to the control unit 1, and the result is displayed on the display unit so as to be notified to the user.

As described above, the slots are provided with the terminals having different lengths, and it is allowed to identify the three states of module has not been inserted, has been completely inserted and has been incompletely inserted. If it is decided that the module has been incompletely inserted in the slot, then it is decided if the module is probable to come in contact with the constituent portion of the car-mounted device due to the operation of the constituent portion as will be described later. If it is decided that the contact is probable, operation of the constituent portion is limited to prevent the breakage of the module.

### Embodiment 3

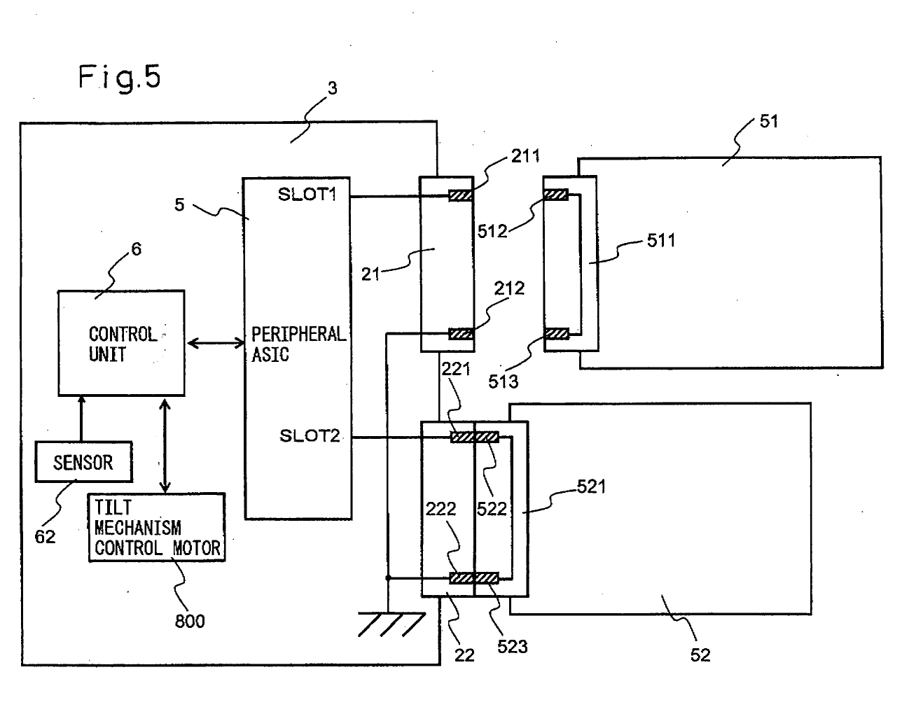

Next, the car-mounted device according to an embodiment 3 will be described. The car-mounted device of the embodiment 3 has a feature on the provision of a sensor for detecting the position of the module in addition to providing the slots with the insertion detection units described in the embodiment 1. FIG. 5 schematically illustrates the constitution thereof. In the embodiment 3, the control unit 6 receives a signal from a sensor 62. In other respects, however, the constitution is the same as that of the embodiment 1 and is not described here in detail The sensor 62 may be an optical sensor and can be provided, for example, near the terminal in the slot. Upon being provided near the terminal, the module that is inserted in the slot can be detected even if it has not been connected to the terminal. In FIG. 5, for example, the first extension module 51 has not been connected to the terminals of the first connector 21 in the first slot. However, if the presence of the first extension module 51 can be detected by the sensor 62, then it is made possible to recognize that the first extension module 51 has not been completely inserted. Further, if the sensor 62 is provided near the insertion port of the slot, the module can be decided not to have been inserted in the slot if it is not detected by the sensor 62. As shown in FIG. 5, on the other hand, if connection is made to the second connector 22 as attained by the second extension module 52, the second extension module 52 is detected to have been completely inserted in the second slot from a change in the signal at the terminal SLOT2.

As described above, the slot is provided not only with the terminals but also with the independent sensor to detect the state of connection; i.e., it is possible to identify if the module is completely inserted, incompletely inserted, or has not been inserted in the slot. Upon correctly identifying the state of insertion of the module in the slot as described above, it is made possible to suppress the module from being broken by the operation of the moving part of the car-mounted device. With the car-mounted device being provided with a plurality of slots, further, the state of insertion is separately identified for each of the slots. Even if the slots are provided in a plural number, therefore, breakage to the modules can be prevented.

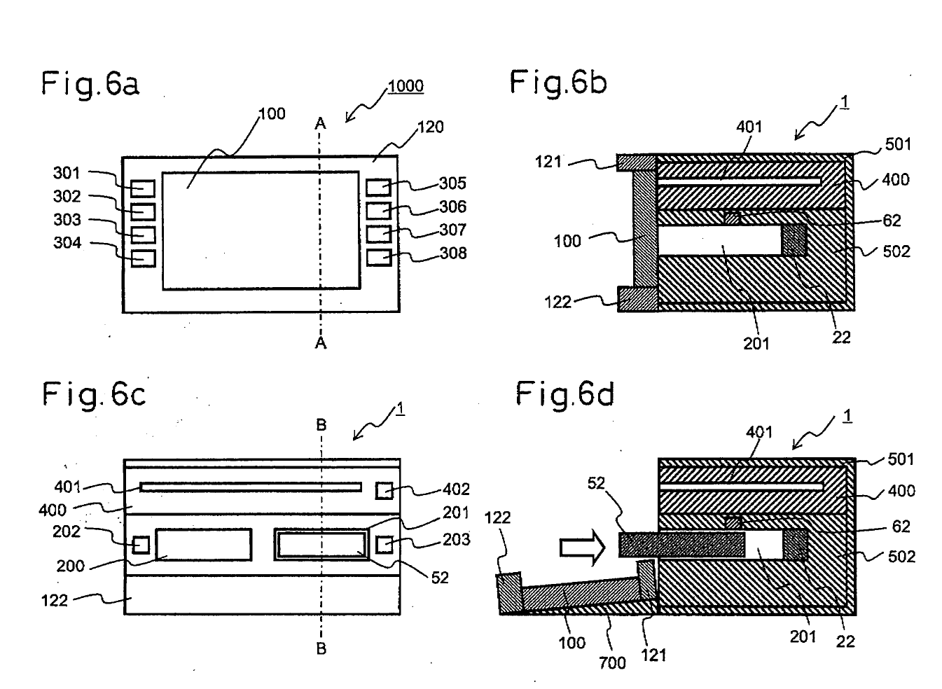

Next, a procedure for detecting the state where the module is inserted in the slot of the car-mounted device will be described more concretely. FIG. 6 shows the car-mounted device equipped with the display unit 1000 on the front surface thereof, the display unit 1000 being allowed to be opened and closed by tilting the display unit 1000 thereof while pulling the lower side by using a slide mechanism 700. FIG. 6a is a schematic view of the car-mounted device as viewed from the front surface in a state where the display unit 1000 is closed. The display unit 1000 is provided with a display device 100, an outer frame 120 and escutcheon keys 301 to 308. The escutcheon keys 301 to 308 are arranged for operating the functions of the car-mounted device. FIG. 6b is a sectional view along A-A in FIG. 6a. The display device 100 is held by an upper outer frame portion 121 and by a lower outer frame portion 122. On the back side of the display device 100, a car-mounted device housing 501 incorporates a disk unit 400 and a module extension unit 502. The disk unit 400 is provided with a slot 401 for disk, and is capable of reading CD, DVD, etc. and writing therein. The module extension unit 502 is provided with a second module insertion slot 201 and a second connector 22. A sensor 62 is provided at an upper part of the second module insertion slot 201 in front of the second connector. FIG. 6b shows a state where no extension module has been inserted in the second module insertion slot 201.

Next, described below is a procedure for inserting the module in the car-mounted device 1. FIG. 6c shows a state where the display unit 1000 is tilted to expose the front surface of the car-mounted device 1. A disk eject button 402 is provided at an end portion of the disk slot 401 of disk unit 400 of the car-mounted device 1. The module extension unit 502 is provided with a first module insertion slot 200 and a second module insertion slot 201, and module eject buttons 202 and 203 are provided at end portions thereof. FIG. 6c shows a state where the second extension module 52 is inserted in the second module insertion slot 201.

FIG. 6d is a sectional view along B-B in FIG. 6c and shows a state where the second extension module 52 is inserted in the second module insertion slot 201. Here, the leading end of the second extension module 52 is reaching the position of the sensor 62 provided in the second module insertion slot 201 and, therefore, the module is detected to have been inserted. However, the leading end of the second extension module 52 has not been connected to the second connector terminal provided in the second module insertion slot 201 of the car-mounted device 1. Therefore, the module is not in a state of being completely inserted. In this case, therefore, the operation of the display unit 1000 is limited. Concretely, as shown in FIG. 6d, if not completely inserted, the second extension module 52 may often protrude from the second module insertion slot 201. Here, if it is attempted to return the display unit 1000 back to the initial position, the second extension module 52 may come in contact with the upper outer frame portion 121 and may be broken. According to the present invention, therefore, in case it is so decided that the module has not been completely inserted, the operation of the moving portion such as the display unit 1000 is limited to prevent breakage to the module.

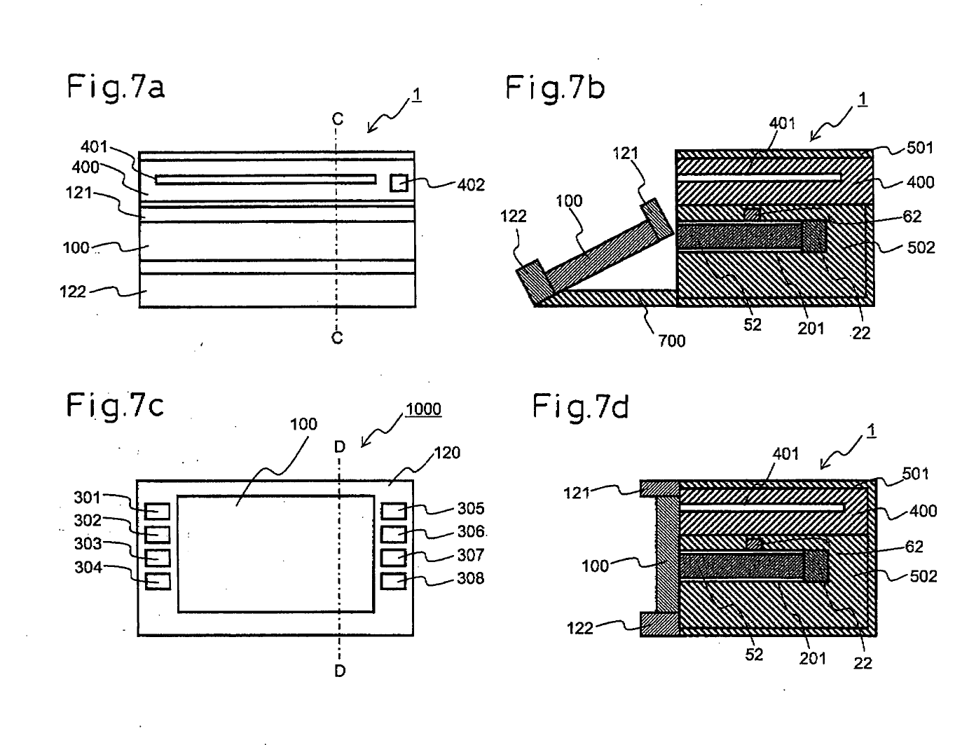

Next, described below is a procedure of operation of when the module is completely inserted. FIG. 7b is a cross section along C-C in FIG. 7a. Referring to FIG. 7b, if the leading end of the second extension module 52 is inserted up to a position where it is connected to the second connector 22 in the module insertion slot 201, the second extension module that is completely inserted is detected relying on a detection signal from the sensor 62 and a detection signal from the terminal SLOT2a as described in the embodiment 3. In this case, the control unit in the car-mounted device releases the limitation of operation of the display unit 1000 and, therefore, the display unit 1000 can be returned back to the initial position by the slide mechanism 700. Namely, the module has been held in the slot and does not come in contact with the display unit; i.e., the module is not broken.

Next, described below is a state where the display unit is finally returned back to its initial position. FIG. 7c is a front view of when the display unit 1000 is returned back to its initial position, and FIG. 7d is a sectional view along D-D in FIG. 7c. As shown in FIG. 7d, since the display unit is returned back to the initial position after having detected the module that is completely inserted, it is allowed to insert the module without causing breakage to the module.

The embodiment has described the case where the module was inserted in the second module insertion slot 201 When the module is inserted in the first module insertion slot 200, the operation can also similarly be conducted by disposing another sensor (not shown) at the same position as that of the sensor 62. In inserting the modules in both the first module insertion slot 200 and the second module insertion slot 201, in case an incompletely inserted state is detected in either one of the slots, operation of the moving portion such as the display unit is limited. The moving portion is permitted to be operated after the two modules have been completely inserted. Even when the two modules are simultaneously inserted, therefore, breakage of the modules can be similarly suppressed.

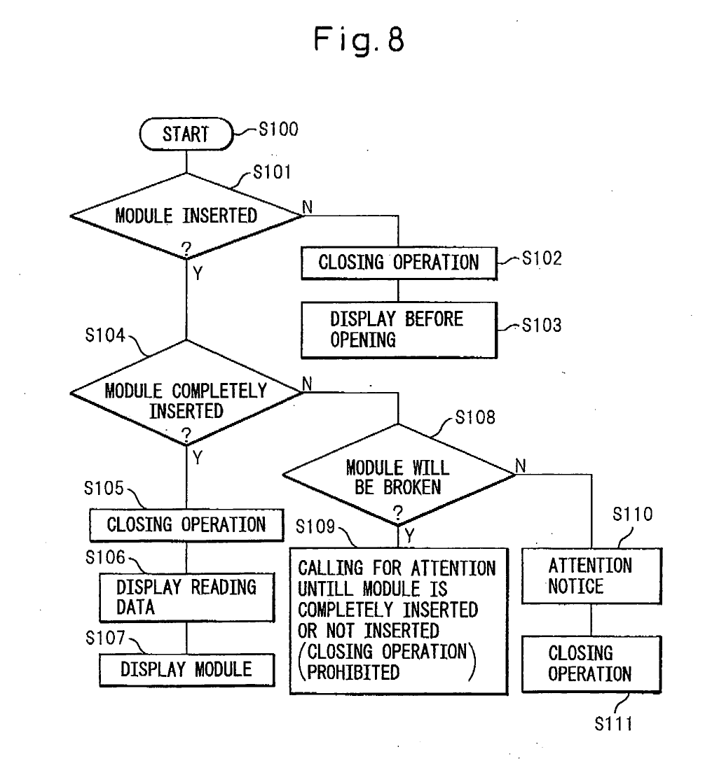

Next, a series of flows of from a state where the display unit is tilted to expose the slots (opened state) up to a state where the modules are inserted and the display unit is returned back to the initial position (closed state) will be described in further detail with reference to a flowchart of FIG. 8. At step S101, first, it is decided if the module is inserted. Concretely, decision is rendered depending upon the presence of detection signal from the sensor 62 shown in FIG. 7. If no module has been inserted, there is no probability of breakage to the module. At step S102, therefore, the operation is executed for closing the display unit. After closed, the picture of before being opened is displayed at step S103.

If the module that is inserted is detected, it is decided at step S104 if the module has been completely inserted. Concretely, the decision is rendered relying upon the presence of detection signal from the terminal in the slot. If it is decided that the module has been completely inserted, it is decided that the module will not be broken despite the display unit is operated. At step S105, therefore, the closing operation is executed. After the start of the closing operation, the data are read out from the inserted module at step S106, and this fact is displayed on the display screen. When reading of the data is completed, at step S107 the fact that reading of the data has been completed is displayed on the display screen.

If it is so decided that the module has been inserted but incompletely, then it is decided at step S108 if the module is probable to be broken. Concretely, this can be attained by providing, in addition to the above-mentioned sensor, a sensor in the slot so as to detect the module that is present, the sensor being provided at a position where it will not come in contact therewith despite the moving portion has moved. In case it is so decided that the module is probable to be broken, a display, for example, is made at step S109 on the display screen to call attention of the user and the closing operation is limited until the module is completely inserted or the module is ejected. On the other hand, if it is so decided that there is no probability of breakage to the module, the fact that the module has not been completely inserted is displayed on the display screen at step S110 to call attention of the user while executing the closing operation at step S111. In this case, the closing operation of the display unit may help push the module therein so that the module that is incompletely inserted may now be completely inserted.

As described above, upon monitoring the state of insertion of the module and deciding the probability of breakage to the module, it is made possible to prevent the module from being broken by the operation of the moving portion. Further, if there is no probability of breakage despite the module has not been completely inserted, the moving portion is permitted to operate to improve convenience for the user.

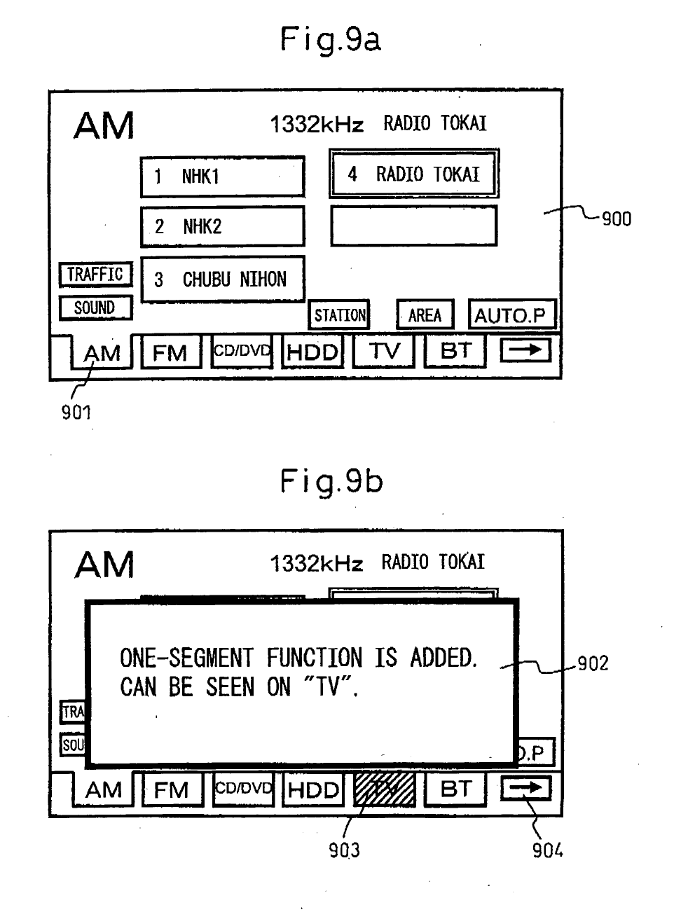

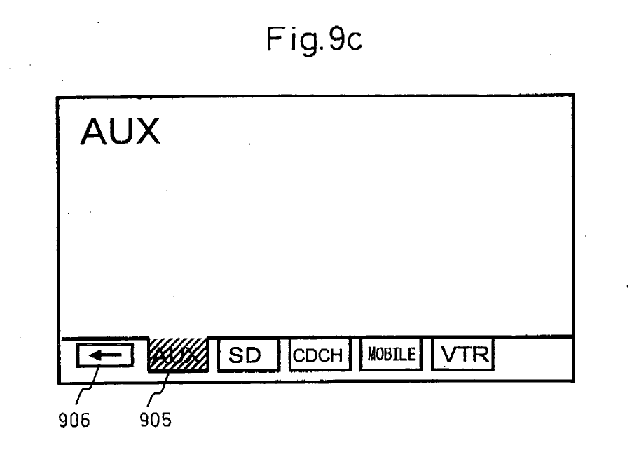

Next, described below is a display sequence on the display screen of when the module is inserted in the car-mounted device. FIG. 9 is a view illustrating a display screen after a new module is inserted. First, FIG. 9a shows a display screen of before the module is inserted. Shown here is a state where the AM tuner is in operation, the screen 900 displaying the content of AM broadcast, and a tab 901 at a lower part of the screen on the display screen indicating the AM tuner is in operation. In this state, if a TV tuner for one segment broadcasting is inserted in the slot, then this fact is displayed on a display frame 902 as shown in FIG. 9b, and a tab 903 indicates an identification pattern to represent the kind of the module that is inserted. This, further, enables the user to recognize the kind of the module that can be used. At this moment, the tab 903 may be flashed for a predetermined period of time so that the user can recognize the addition of the new module.

Further, when an AUX module which is another module is added as shown in FIG. 9c, a tab 905 is indicated on a separate screen while being flashed for a predetermined period of time. Thus, the kind of the module is conspicuously indicated every time when a new module is added so that the user can learn the kind of the module that is newly added. When the modules are inserted in a plural number as in this embodiment and the number of the tabs cannot be contained in one screen, a button 904 on a touch panel (FIG. 9b) for movement to the next page is touched to move to the next page. To return to the initial screen, a button 906 on the touch panel (FIG. 9c) is touched to return to the initial screen.

The above tab may be indicated in a manner of being added onto the display screen every time when a new module is inserted. Alternatively, tabs of the usable functions may be provided in advance and, when not usable, may be indicated in an inconspicuous color such as gray or monochromatic color on the display screen and, when a module is added, may be colored in black or in other color so as to become conspicuous and identified by the user.

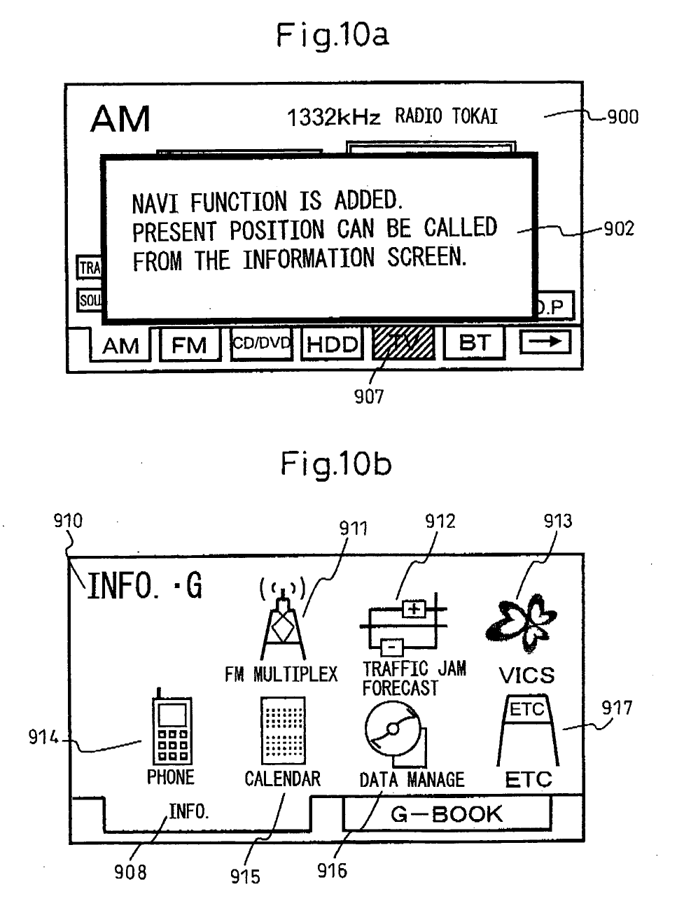

The above embodiment has indicated the kind of the module that was inserted. Some modules, however, may have related functions. Described below is a display sequence of when such a module is inserted. FIG. 10 shows a display screen of when a related function is added by the addition of a new module. Referring to FIG. 10a, if a navigation module is inserted while displaying an AM tuner operation screen 900, the fact that the navigation function is added accompanying the insertion of the navigation module is displayed on a display frame 902 so as to be notified to the user. To confirm the function related to the navigation function, the user depresses the information key which is an escutcheon key to display an information screen 910 shown in FIG. 10b. In this embodiment, icons are indicated, such as FM multiplex 911, traffic jam forecast 912, VICS 913, telephone 914, calendar 915, data management 916 and ETC (electronic toll collection system) 917. When the traffic jam forecast 912, VICS 913 and calendar 915 are newly added as functions related to the navigation function, icons representing the added functions may be flashed for a predetermined period of time so as to be recognized by the user. As described above, not only the added modules but also the related functions added accompanying the insertion of the modules are indicated to improve convenience for the user.

Here, the icons may be added and indicated on the display screen every time when the new module is inserted. Alternatively, icons of the usable functions may be provided in advance and, when not usable, may be indicated in an inconspicuous color such as gray or monochromatic color on the display screen and, when a module is added, may be colored in black or in other color so as to become conspicuous and identified by the user.

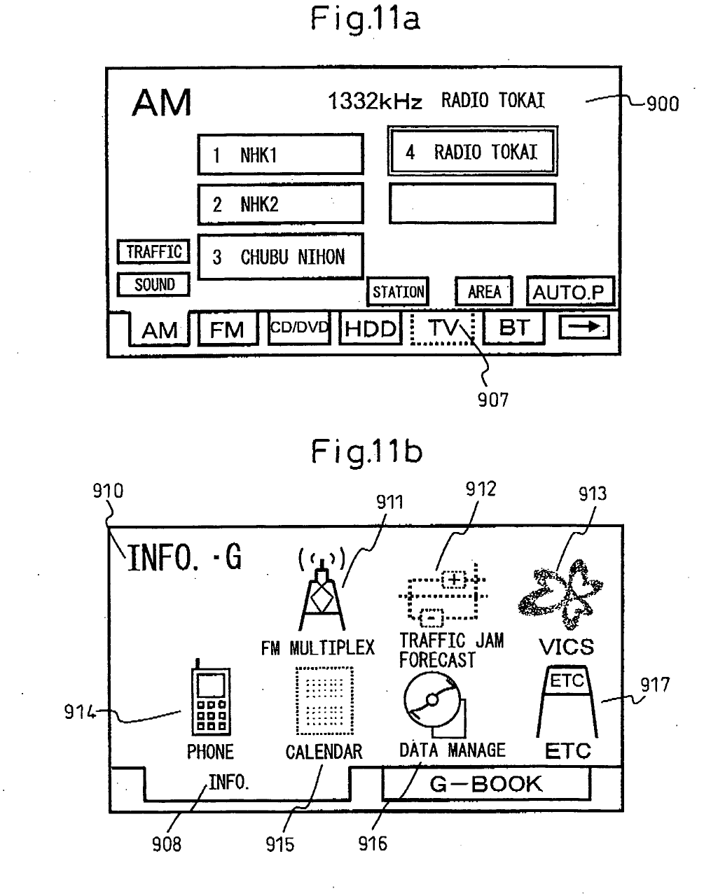

Next, described below with reference to FIG. 11 is a display sequence of when the module is taken out. FIG. 11a shows a display screen of when a TV module is ejected. In this case, a tab 907 for TV is displayed in a translucent manner to indicate that the TV tuner module is ejected. If the navigation module is ejected, on the other hand, a related function is also erased. In this case as shown in FIG. 11b, the icons of traffic jam forecast 912, VICS 913 and calendar 915 which are the related functions that have been deleted are displayed in a translucent manner to indicate that the above functions are erased. On the other hand, it can be found that the functions of FM multiplex 911, telephone 914, data management 916 and ETC 917 still remain since indicating manner of these icons has not been changed. Thus, the module that is once inserted and is, thereafter, ejected and the functions that are erased accompanying the ejection of the module can be identified by the user by changing the manner of indicating the tabs and icons.

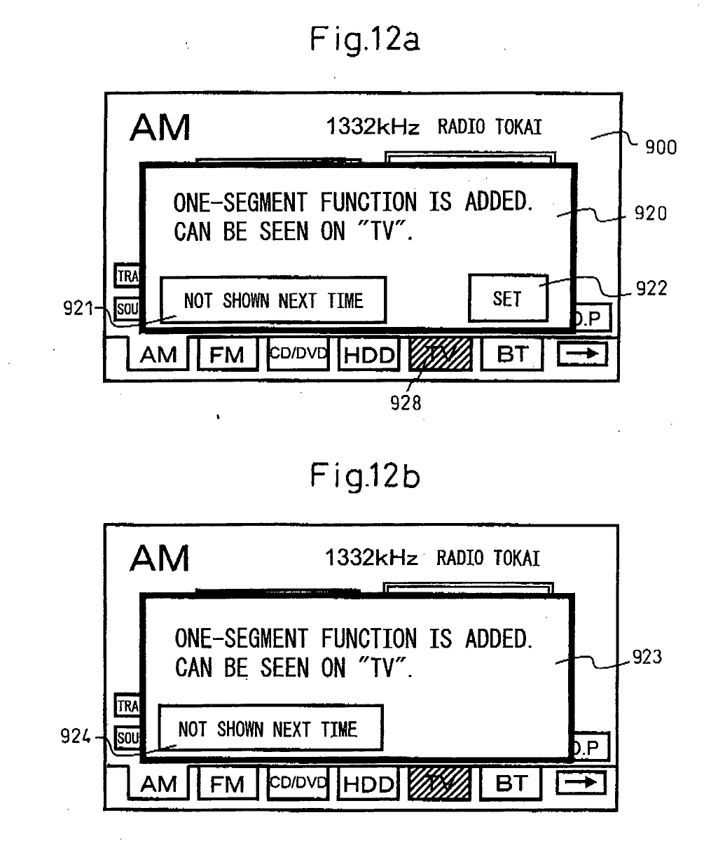

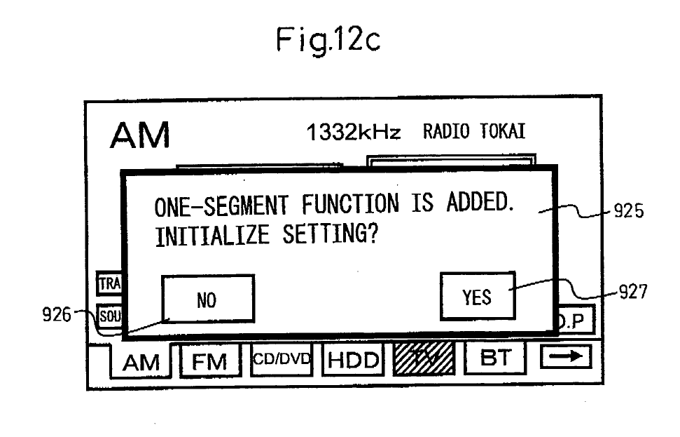

Next, described below is another example related to the method of displaying the screen after the module is added. FIG. 12a illustrates a case of when a one segment broadcasting tuner module is inserted while the AM tuner is in operation. The one segment broadcasting tuner added onto the AM tuner operation screen 900 is displayed on the display frame 920, and a button 921 is displayed in the display frame 920 permitting the user to select if the above screen be displayed in the future. By permitting the user to select as described above, the device can be customized to suit the user's preferences. When a further new one segment broadcasting tuner module is inserted and various settings are required, a set button 922 is displayed to give chances of setting to the user. In this case, further, a tab 928 is flashing for a predetermined period of time.

On the other hand, if the one segment broadcasting tuner module was once inserted in the past and no setting is necessary, then a button 924 only may be displayed for selecting the necessity of display in the display frame 923 without displaying the setting buttons. Thus, necessary buttons only are displayed so that the user does not have to execute unnecessary operations.

Described below with reference to FIG. 12c is a display in the case when there is inserted a module of the same kind as the module inserted in the past but of a different version. For example, when a one segment broadcasting tuner module of a different version is inserted in the slot, it may often be desired to newly set again various conditions. In such a case, a display is made in the display frame 925 for querying the necessity for initializing the setting, and buttons 926, 927 are displayed for selecting the result of decision. Thus, the user is allowed to select the necessity for initializing the setting and finds it easy to customize as desired.

### Embodiment 4

Next, described below are the car-mounted device and the method of inserting modules according to the present invention.

When the module that is used being inserted in the slot is to be ejected therefrom, the module must be ejected while managing the operating state of the module to prevent corruption of the data stored in a memory of the module. The operation for ejecting the module is accompanied by a probability of corruption of the data. Therefore, the operation for ejecting the module must not be erroneously executed. Next, described below is the method of ejecting the module.

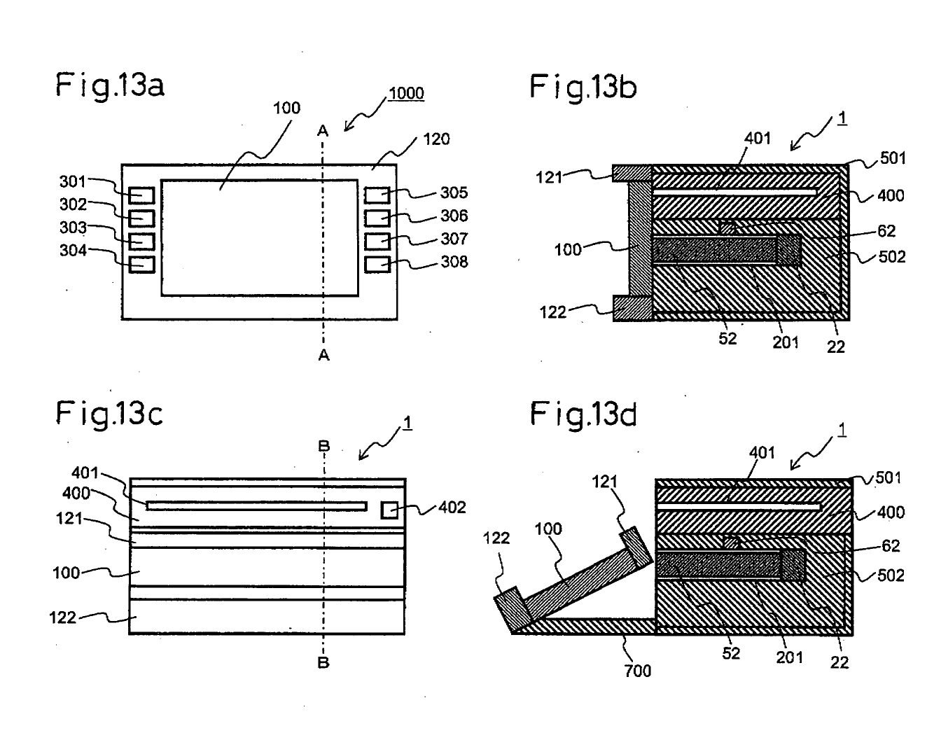

FIG. 13 shows the car-mounted device having the display unit 1000 on the front surface. The display unit 1000 can be opened and closed by sliding the lower portion thereof toward the user so as to be tilted by the slide mechanism 700. FIG. 13a is a schematic view of the car-mounted device 1 of when it is viewed from the front surface in a state where the display unit 1000 is closed. The display unit 1000 is provided with the outer frame 120 and escutcheon keys 301 to 308. The escutcheon keys 301 to 308 are arranged for operating the functions of the car-mounted device 1. FIG. 13b is a sectional view along A-A in FIG. 13a. The display device 100 is held by the upper outer frame portion 121 and by the lower outer frame portion 122. On the back side of the display unit 1000, there are incorporated a disk unit 400 contained in the car-mounted device housing 501 and a module extension unit 502. The disk unit 400 is provided with a slot 401 for disk enabling the data to be read out, or written in, the CD, DVD, etc. The module extension unit 502 is provided with a slot 201 for inserting a second module, and a second connector 22. A second sensor 62 is provided at an upper part of the slot 201 for inserting the second module and in front of the second connector. FIG. 13b shows a state where an extension module is inserted in the slot 201 for inserting the second module.

Next, described below is a procedure for ejecting the module from the car-mounted device 1. FIG. 13c shows a state where the display unit 1000 is tilted by the slide mechanism 700 and part of the front surface of the car-mounted device 1 is exposed. A disk eject button 402 is provided at an end portion of the slot 401 for disk in the disk unit 400 of the car-mounted device 1. In this state, the disk can be inserted or taken out. However, the module extension unit is concealed by the display unit 1000 and cannot be operated.

FIG. 13d is a sectional view along B-B in FIG. 13c and shows a state where the second extension module 52 is inserted in the slot 201 for inserting the second module. Since the module extension unit has been concealed by the display unit 1000 as described above, there is no probability of erroneously operating the switch for ejecting the module.

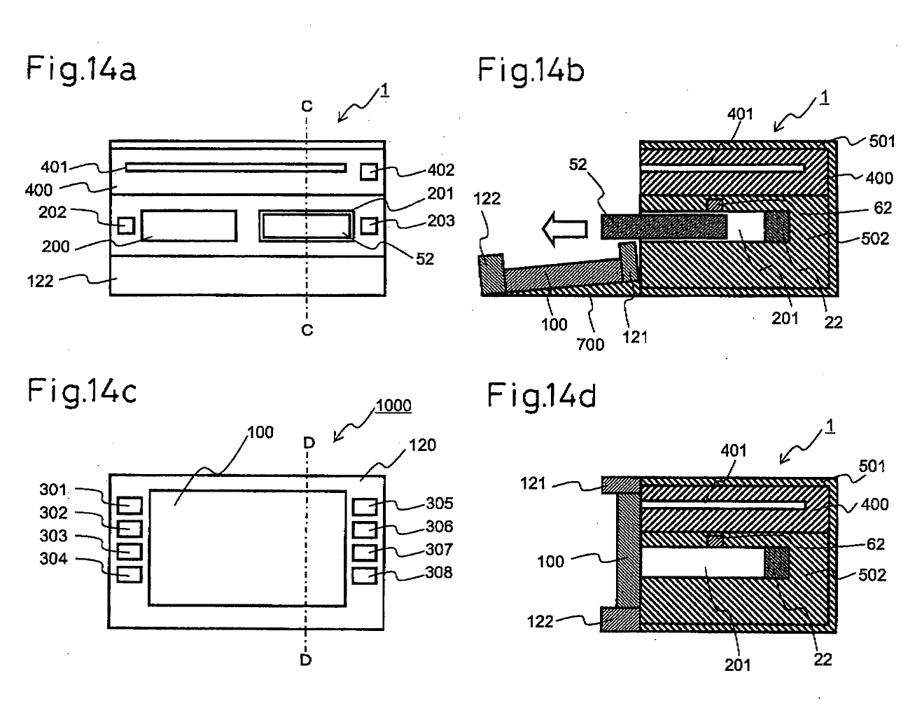

Next, described below is a procedure of operation of when the module is to be ejected. If the display unit 1000 moves down to its lowest position by the slide mechanism 700, the module extension unit 502 is exposed as shown in FIG. 14a. The module extension unit 502 is provided with the slot 200 for inserting the first module and the slot 201 for inserting the second module. Module eject buttons 202 and 203 are provided at the end portions thereof. The module eject buttons 202 and 203 are physical switches for ejecting the modules. Further, FIG. 14a shows a state where the second extension module 52 is inserted in the slot 201 for inserting the second module.

To eject the second extension module 52 from the slot 201 for inserting the second module, the module eject button 203 is depressed. In the operation of the first time, if the module is in operation, the data is protected. Upon limiting the ejection of the module as described above, the data is prevented from being corrupted while the module is in operation. Next, protection of the data is completed, the module is shifted into a state where it can be ejected, and the module eject button 203 is operated twice to eject the module.

FIG. 14b is a cross section along C-C in FIG. 14a. As shown in FIG. 14b, upon depressing the module eject switch 203 twice, the second extension module 52 is ejected to the operation side. In this case, the display unit 1000 is at a position where it does not come in contact with the module ejected from the slot, and there is no probability of breaking the module.

The module may be automatically and completely ejected from the slot but may also be partly ejected so as to be taken out by the user. If it is attempted to return the display unit 1000 back to the initial position while the module is being partly ejected, then it may happen that the module comes in contact with the upper frame portion 121 of the display unit 1000. In such a case, therefore, the contact between the module and the display unit 1000 can be avoided in a manner as described below. That is, the leading end of the second extension module 52 is at the position of the second sensor 62 provided in the slot 201 for inserting the second module and, therefore, the module that is remaining can be detected. However, the leading end of the second extension module 52 has not been connected to the second connector terminal provided in the slot 201 for inserting the second module of the car-mounted device 1. Therefore, the module is not in the completely inserted state. In this case, therefore, the operation of the display unit 1000 is limited. Concretely, if the ejection is not complete as shown in FIG. 14b, the second extension module 52 may assume a state of being protruded from the slot 201 for inserting the second module. At this moment, if it is attempted to return the display unit 1000 back to the initial position, then the upper outer frame portion 121 comes in contact with the second extension module 52 which, therefore, is damaged. In this case, if it is decided that the module has not been completely ejected, operation of the moving portion of the display unit 1000 is limited to prevent the module from being broken.

Next, described below is a state where the display unit is finally returned back to the initial position. FIG. 14c is a front view of when the display unit 1000 is returned back to the initial position, and FIG. 14d is a sectional view along D-D in FIG. 14c. As shown in FIG. 14d, the display unit is returned back to the initial position after having detected the module that is completely ejected. Therefore, the module can be inserted without being broken.

The above embodiment has dealt with the case of ejecting the module that was inserted in the slot for inserting the second module. When the module inserted in the slot 200 for inserting the first module is also to be ejected, it is allowable to eject the module without corruption of the data by conducting the ejecting operation while detecting the operating state of the module. In this case, if the modules inserted in both the slot 200 for inserting the first module and in the slot 201 for inserting the second module are to be ejected, ejecting the module is limited in case the operation is detected in either slot. After the data of the module to be ejected has been completely protected, the module is allowed to be ejected. Thus, if either one of the two modules that are inserted is to be ejected, the data of the module is similarly suppressed from being broken.

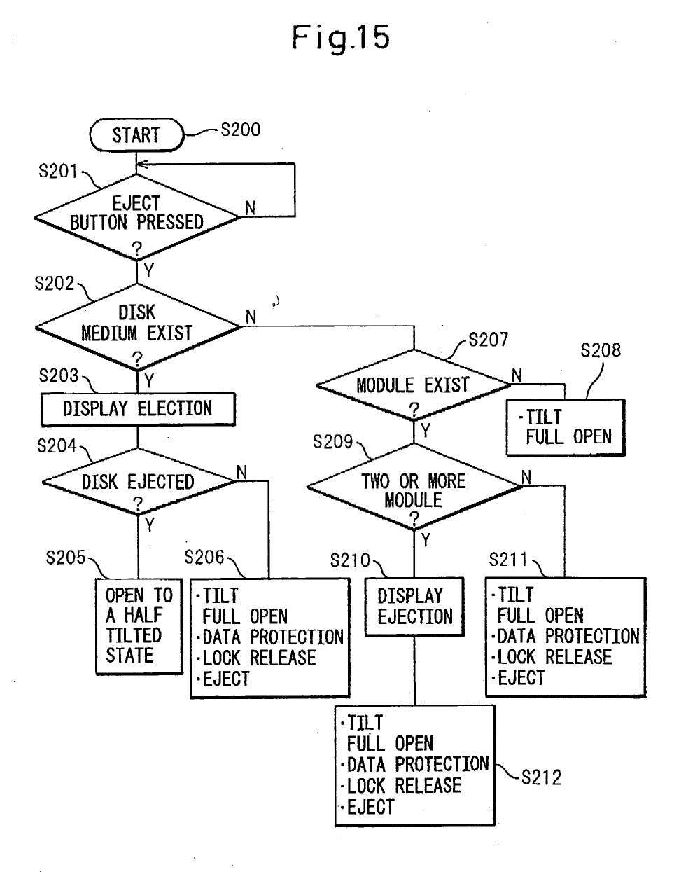

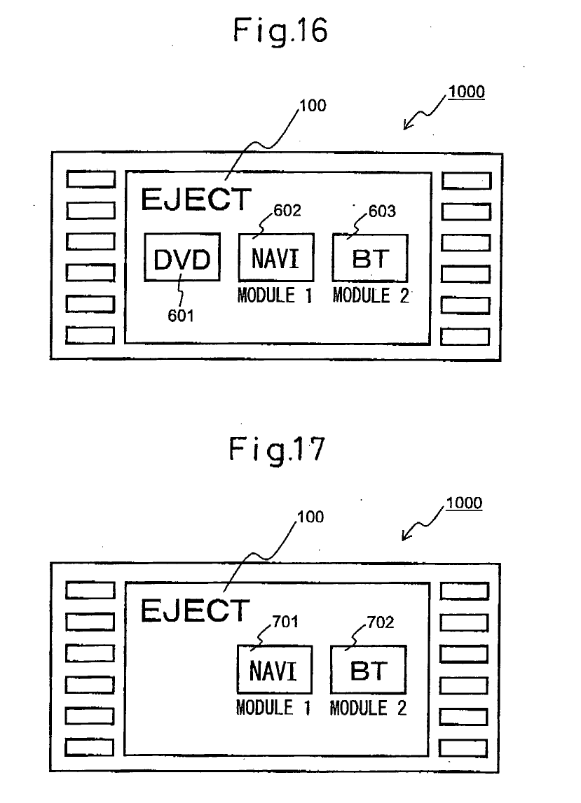

Next, a series of flows of from a state where the module is inserted and the display unit is covering the slots (closed state) up to a state where the display unit is tilted forward to expose the slots and the module is ejected(opened state) will be described in further detail with reference to a flowchart of FIG. 15. At step S201, first, it is decided if the eject button is depressed. If it has not been depressed, the routine returns back to the initial state to assume the standby state. If the eject button is depressed, it is decided at step S202 if a disk medium is inserted in the CD/DVD unit. If the disk medium has been inserted, an eject screen is displayed on the display device at step S203. FIG. 16 shows a concrete display screen. Shown here is a case where a DVD is inserted as the disk medium. As shown in FIG. 16, there are displayed a first button 601 for disk medium, a second button 602 and a third button 603 for modules, and the operation can be executed upon touching the screen. The screen, further, displays the kinds of modules inserted in the slots. Shown here is a case where a navigation module (NAVI) and the Bluetooth (registered trademark) module (BT) are inserted.

Next, an object to be ejected is selected from the screen of FIG. 16. At step S204, it is decided if the disk medium is selected to be ejected. If the disk medium is selected to be ejected upon touching the first button 601 in FIG. 16, tilting the display unit 1000 (TILT) is limited to a level on which the disk unit appears (see FIG. 13d). Therefore, the button for ejecting the module is maintained covered with the display unit, and the module is prevented from being erroneously ejected.

If the disk medium is not to be ejected at step S204, then the module is ejected. At step S206, therefore, the display unit 1000 is completely opened (see FIG. 14b). Next, the data is protected for the module that is selected to be ejected by depressing the eject button once, and the lock mechanism against module ejection is released. Here, the lock mechanism stands for a mechanism which physically prevents the ejection of the module. Upon depressing the eject button twice, further, ejecting the module is executed. Thus, the data is protected prior to ejecting the module, and the data is prevented from being corrupted by the ejection of the module.

If it is decided at step S202 that no disk medium has been inserted, then it is decided at step S207 in which one of the plurality of slots the module is inserted. If it is decided that the module has been inserted in none of the plurality of slots, then there is no module that is in operation at step S208, and the module display unit is opened without protecting the data.

Next, if it is decided at step S207 that the module has been inserted in any one of the plurality of slots, it is decided at step S209 if the number of the modules that are inserted is two or more. If only one module has been inserted, the display unit is opened at step S211 without selecting the module, the data of the module is protected by the operating the eject button once, and the lock mechanism is released. Next, the module is ejected by operating the eject button twice. If only one module is inserted, there is no need of selecting the module to be ejected. Therefore, the module selection screen is not displayed to improve the operability.

Next, if two or more modules have been inserted in the slots at step S209, an eject screen is displayed at step S210 for selecting the module to be ejected. Concretely, as shown in FIG. 17, a plurality of module selection buttons are displayed on the screen. For instance, if the navigation module (NAVI) and the Bluetooth (registered trademark) module (BT) are inserted, either one of them can be selected by touching either a first module selection button 701 or a second module selection button 702. If either one module is selected, the display unit is opened at step S212, the data of the module is protected by once operating the eject button provided for the slot in which has been inserted the module that is to be ejected, and the lock mechanism is released. Next, the module is ejected by operating the eject button twice. If a plurality of modules have been inserted as described above, the data is protected for only the module that is to be ejected. Therefore, the modules that are not to be ejected are allowed to operate continuously, and only the required ejection operation is executed without disturbing the operating environment.

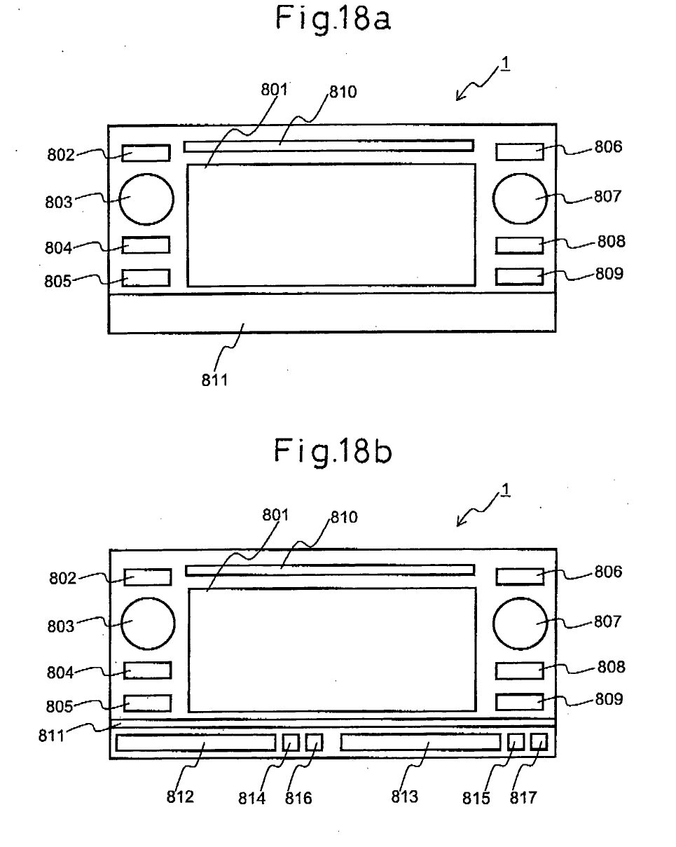

The above embodiment has dealt with the case where the display unit 1000 was disposed so as to cover the disk drive unit and the module extension unit. If the display screen is smaller than the area of the front surface of the car-mounted device, the slots for inserting the modules may be arranged in parallel with the display screen. An embodiment of this case is shown in FIG. 18. Described here is a case where a lid is provided in front of the insertion ports of the slots. Upon providing the lid, the colors of the modules that are inserted can be concealed by the color of the lid making it possible to maintain consistency of color of the car-mounted device. FIG. 18a shows a state where the lid is closed. On the front surface of the operation panel as shown in FIG. 18a, there are arranged a display unit 801, a display change-over button 802, a menu selection button 803, an AM/FM change-over button 804, a CD selection button 805, a disk eject button 806, a volume 807, a SEEK button 808, a TRACK button 809 and a CD insertion slot 810. A lid 811 is provided at a lower part of the display unit 801. If a portion of the lid 811 is depressed once, the lower part of the lid 811 opens upward with the upper part of the lid as a fulcrum.

FIG. 18b is a schematic view of the front surface of the operation panel of when the lid 811 is opened. Upon opening the lid 811, there appear the module insertion slot and the indicators. Shown here is a case of when there are two slots. The slot comprises a first slot 812 and a second slot 813. On the right sides of these slots, there are provided a first indicator 814 and a second indicator 815, as well as a first eject button 816 and a second eject button 817. The first eject button 816 and the second eject button 817 are physical switches for ejecting the modules. The indicators turn on at the time of executing the data protection, and call attention so that the user will not execute the module eject operation.

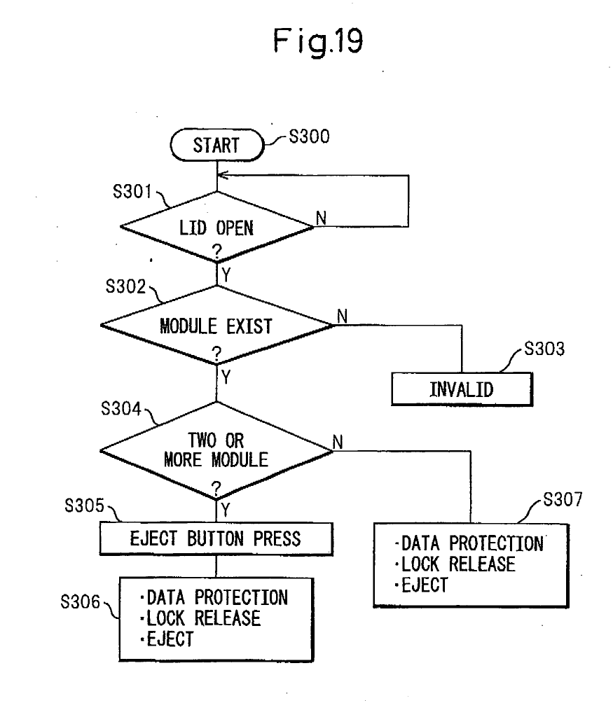

Next, a sequence for ejecting the module of when the lid is provided as described above, will be described using a flowchart of FIG. 19. At step S301, first, it is decided if the lid opening operation is executed. If the opening operation has not been executed, the routine returns back to the start to wait for the opening operation. If the lid opening operation is executed, it is decided at step S302 if the module has been inserted in any one of the plurality of slots. If the module has been inserted in none of the plurality of slots, it is decided at step S303 that the operation for ejecting the module is invalid.

If it is decided at step S302 that the module has been inserted in any one of the plurality of slots, it is decided at step S304 if the number of the inserted modules is two or more. If two or more modules have been inserted, a state is assumed at step S305 waiting for the depression of the eject button of the slot in which the module to be ejected has been inserted. If the eject button is depressed once at step S305 for the slot in which the module to be ejected has been inserted, the data of the module to be ejected is protected, and the lock mechanism is released after the data has been protected. Next, if the eject button is depressed twice, the module is ejected.

At step S304, if only one module has been inserted, there is no need of selecting the module to be ejected. Therefore, the data of the module is protected without depressing the eject button, and the lock mechanism is released after the data has been protected. The module is ejected upon depressing the eject button after the lock mechanism has been released. As described above, the timing for protecting the data is controlled depending on the number of the inserted modules preventing the user from executing wasteful operation. Further, the data of the module is protected by depressing the eject button once, and the module is allowed to be ejected after the data has been protected making it possible to suppress the data from being corrupted by the ejection of the module. Further, if the plurality of modules have been inserted, the data is protected for only the module that is to be ejected. Therefore, the modules that are not to be ejected are allowed to continuously operate. Thus, the module ejection operation can be executed without disturbing the operating environment.

Though the above embodiment has described the case of being provided with the eject button, the invention can similarly be applied to a case of being provided with a module exchange button instead of the eject button. The module exchange button can be used for a case of ejecting the inserted module and inserting another module in its place, and the content of its operation is substantially the same as that of the ejecting operation.

The foregoing description has dealt with case where the main unit possessed two slots for inserting the modules. The invention, however, can similarly be applied even when there are three or more slots.

What is claimed is:

1. A car-mounted device comprising:
a plurality of slots for inserting modules;
detection units for detecting a state where said modules are inserted in said slots; and
a control unit for issuing a notice based on the state where said modules are inserted detected by said detection units;
wherein if said detection unit detects that said module is incompletely inserted in said slot, said control unit decides whether said module is probable to come in contact with a constituent portion of said car-mounted device due to an operation of the constituent portion and issues a notice for calling attention.

2. The car-mounted device according to claim 1, wherein if said control unit decides that there is a probability of contact, the operation of said constituent portion is limited.

3. The car-mounted device according to claim 1, further comprising a display unit, wherein said control unit identifies the kinds of said modules inserted in said slots and displays identification patterns to represent the kinds of said modules on said display unit.

4. The car-mounted device according to claim 3, wherein said identification patterns are displayed flashing for a predetermined period of time after said modules are inserted.

5. The car-mounted device according to claim 3, wherein when said module has a function related to the kind of said module, a pattern representing the related function is displayed on said display unit.

6. The car-mounted device according to claim 5, wherein the pattern representing the function is displayed flashing for a predetermined period of time after said module is inserted.

7. The car-mounted device according to claim 3, wherein after said module inserted in said slot is ejected, said identification pattern is displayed in a translucent manner on said display unit.

8. The car-mounted device according to claim 5, wherein after said module inserted in said slot is ejected, said pattern representing the function is displayed in a translucent manner on said display unit.

9. The car-mounted device according to claim 1, further comprising switches for ejecting said modules inserted in said slots, wherein said control unit controls ejection of said modules from said slots, limits the ejection of said module when said switch is operated in a state where said module is in operation, and when said switch is operated once, shifts said module to a state where it can be ejected, protects the data of said module and finishes the operation of said module and when the switch is operated twice, ejects said module.

10. A car-mounted device comprising:
a first unit which is a disk drive unit having an operation portion;
a second unit having slots for inserting modules;
a moving portion covering said operation portion of said first unit and said slots of said second unit;
detection units for detecting states where said modules are inserted in said slots; and
a control unit for controlling an operation of said moving portion;
wherein if said operation portion only of said first unit is operated, said moving portion is controlled that said slots of said second unit are not exposed; and
if said detection unit detects said module that is incompletely inserted in said slot, then said control unit decides if said module is probable to come in contact with a constituent portion of said car-mounted device due to a operation of said constituent portion and issues an attention notice.

11. The car-mounted device according to claim 10, wherein if the control unit decides that there is a probability of contact, then the operation of said constituent portion is limited.

12. The car-mounted device according to claim 10, further comprising a display unit, wherein said control unit identifies kinds of said modules inserted in said slots and displays identification patterns to represent the kinds of said modules on said display unit.

13. The car-mounted device according to claim 12, wherein the identification patterns are displayed flashing for a predetermined period of time after said modules are inserted.

14. The car-mounted device according to claim 12, wherein when said module has a function related to the kind of said module, a pattern representing a related function is displayed on said display unit.

15. The car-mounted device according to claim 14, wherein the pattern representing the function is displayed flashing for a predetermined period of time after said module is inserted.

16. The car-mounted device according to claim 12, wherein after said module inserted in said slot is ejected, said identification pattern is displayed in a translucent manner on said display unit.

17. The car-mounted device according to claim 14, wherein after said module inserted in said slot is ejected, the pattern representing the function is displayed in a translucent manner on said display unit.

18. The car-mounted device according to claim 10, further comprising:
a plurality of slots for inserting modules;
switches for ejecting said modules inserted in said slots; and
a control unit for detecting operating states of said modules inserted in said slots and controlling an ejection of said modules from said slots;
wherein if said switch is operated in a state where said module is in operation, said module is limited from being ejected;
if said switch is operated once, said module is shifted to a state where it can be ejected, data of said module is protected, and the operation of said module is finished; and
if said switch is operated twice, said module is ejected.

19. A method of inserting modules in slots of a car-mounted device having a plurality of slots for inserting said modules, comprising the steps of:
detecting states where said modules are inserted in said slots; and
issuing a notice based on the detected states where said modules are inserted;
wherein if it is detected that the insertion in said slots is not complete, then it is decided if said module is probable to come in contact with a constituent portion of said car-mounted device due to operation of said constituent portion and a notice is issued for calling attention.
